(19) United States
(12) Patent Application Publication
(10) Pub. No.: US 2025/0147704 A1
(43) Pub. Date: May 8, 2025

(54) EXTERNAL CONTROL APPARATUS AND RECORDING MEDIUM

(71) Applicant: Konica Minolta, Inc., Tokyo (JP)

(72) Inventors: Kazuma MARUYAMA, Tokyo (JP); Masatsugu KOUGUCHI, Tokyo (JP); Hiroyuki OOYAMA, Tokyo (JP)

(21) Appl. No.: 18/929,699

(22) Filed: Oct. 29, 2024

(30) Foreign Application Priority Data
Nov. 2, 2023 (JP) 2023-188760

(51) Int. Cl. G06F 3/12

(52) U.S. Cl. CPC G06F 3/1204; G06F 3/1257

(57) ABSTRACT

Disclosed is an external control apparatus of a printer. The printer includes an engine that performs printing on a sheet and a controller that generates raster data to be provided to the engine. The external control apparatus includes: a hardware processor that controls, from an outside of the printer, a color management and adjustment function of the engine and a color management and adjustment function of the controller.

### BACKGROUND OF THE INVENTION

### Technical Field

The present invention relates to an external control apparatus and a recording medium.

### Description of Related Art

In conventional printers, print density calibration has been performed for the purpose of improving gradation characteristics (see JP H11-212313A). The printer disclosed in JP H11-212313A performs printing in accordance with multiple gradation patterns, and determines, on the basis of a result of detection of print density, a plurality of gradation levels at which a density characteristic at the time of printing becomes linear.

Some printers include two elements: an engine that performs printing, and a controller that generates raster data used for the printing in the engine. Regarding color representation in a printer, adjustment of maximum density, density balance, and the like is performed in the engine from the viewpoint of stability of a machine. The controller also has a sheet management function for the sheet feed tray or the like. The controller performs profile creation, density adjustment (calibration), and the like for each sheet type.

FIG. 14 illustrates general color conversion processing. The data of the print document is represented by, for example, CMYK values. The CMYK values of the print document data are assumed to be “C₀M₀ Y₀K₀”. In the controller, “C₀M₀Y₀K₀” are converted into “C₁M₁Y₁K₁” that the engine receives, according to the profile already registered with the controller. At this time, if there is calibration data on the controller side, the calibration data is applied on the controller side, and after the “C₁M₁Y₁K₁” are converted into “C₂M₂Y₂K₂”, the “C₂M₂Y₂K₂” are transmitted to the engine.

Note that depending on the design of the printer, calibration may be performed on the engine side. In this case, on the engine side, the calibration data is applied to the “C₁M₁Y₁K₁” received from the controller and the “C₁M₁Y₁K₁” are converted into the “C₂M₂Y₂K₂”.

In the engine, the maximum density and the density balance are adjusted and the “C₂M₂Y₂K₂” are converted to “C₃M₃Y₃K₃”. The maximum density adjustment is adjustment of the density of a solid CMYK (for example, C=100%). The density balance adjustment is adjustment of in-plane unevenness. An image is printed by the engine on the basis of the “C₃M₃Y₃K₃”.

As described above, in a printer including an engine and a controller, the engine and the controller need to be adjusted in advance in order to print a desired color during printing.

However, in the printer, it is not always desirable to simply perform adjustment on each of the engine and the controller. In practice, it is difficult to obtain colors as intended by the user unless the printer is adjusted in accordance with the sheet at the time of print output.

Hitherto, the adjustment function of the engine has been performed from the viewpoint of conditioning the printer main body. From such a background, when the engine is adjusted in actual operation, a user himself or herself is required to manually set sheets while being conscious of the sheets of a printed product to be output, or confirm the set sheets. In addition, the user himself or herself has to operate a main body panel of the printer to adjust the engine. Since the adjustment is required every time a printing sheet is changed, the user has to perform adjustment operation on the main body panel each time while being conscious of the sheets.

### SUMMARY OF THE INVENTION

The present invention has been made in view of the problem in the conventional art described above, and has an object to increase the efficiency of color adjustment of a printer.

### Solution to Problem

To achieve at least one of the abovementioned objects, according to an aspect of the present invention, an external control apparatus of a printer, wherein:

the printer includes an engine that performs printing on a sheet and a controller that generates raster data to be provided to the engine, and
the external control apparatus comprises:
   a hardware processor that controls, from an outside of the printer, a color management and adjustment function of the engine and a color management and adjustment function of the controller.

To achieve at least one of the abovementioned objects, according to another aspect of the present invention, a non-transitory computer-readable medium reflecting one aspect of the present invention comprises: a program causing a computer connected with a printer including an engine that performs printing on a sheet and a controller that generates raster data to be provided to the engine through a network to perform: functioning as a control unit that controls, from an outside of the printer, a color management and adjustment function of the engine and a color management and adjustment function of the controller.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a system configuration diagram of a color management system in an embodiment of the present invention;

FIG. 2 is a block diagram illustrating a functional configuration of a color management apparatus;

FIG. 3 is a diagram illustrating an example of a data configuration of a printer information table;

FIG. 4 is a diagram illustrating an example of a data configuration of a color management target setting table;

FIG. 5 is a diagram illustrating an example of a data configuration of a color management preset table;

FIG. 6 illustrates an example of a printer information registration screen;

FIG. 7A illustrates an example of a colorimetry setting screen;

FIG. 7B illustrates an example of a profile creation setting screen;

FIG. 7C illustrates an example of a color verification setting screen;

FIG. 8A illustrates an example of a color management preset registration screen;

FIG. 8B illustrates an example of a sheet print setting screen;

FIG. 8C illustrates an example of a profile name setting screen;

FIG. 9 illustrates an example of a menu screen;

FIG. 10 is a sequence diagram at the time of executing the maximum density adjustment or the density balance adjustment;

FIG. 11A illustrates an example of a sheet feed tray selection screen;

FIG. 11B illustrates an example of a chart print screen;

FIG. 11C illustrates an example of a colorimetry screen;

FIG. 11D illustrates an example of a determination result screen;

FIG. 11E illustrates an example of an adjustment screen;

FIG. 12 is a sequence diagram at the time of performing calibration or profile creation;

FIG. 13A illustrates an example of a color management preset list screen;

FIG. 13B illustrates an example of a chart print screen;

FIG. 13C illustrates an example of a colorimetry screen;

FIG. 13D illustrates an example of a result screen; and

FIG. 14 is a diagram illustrating general color conversion processing in a printer including an engine and a controller.

### DETAILED DESCRIPTION

Hereinafter, embodiments of an external control apparatus and a recording medium storing a program according to the present invention will be described with reference to the drawings. However, the scope of the present invention is not limited to the illustrated examples.

### [Configuration of Color Management System]

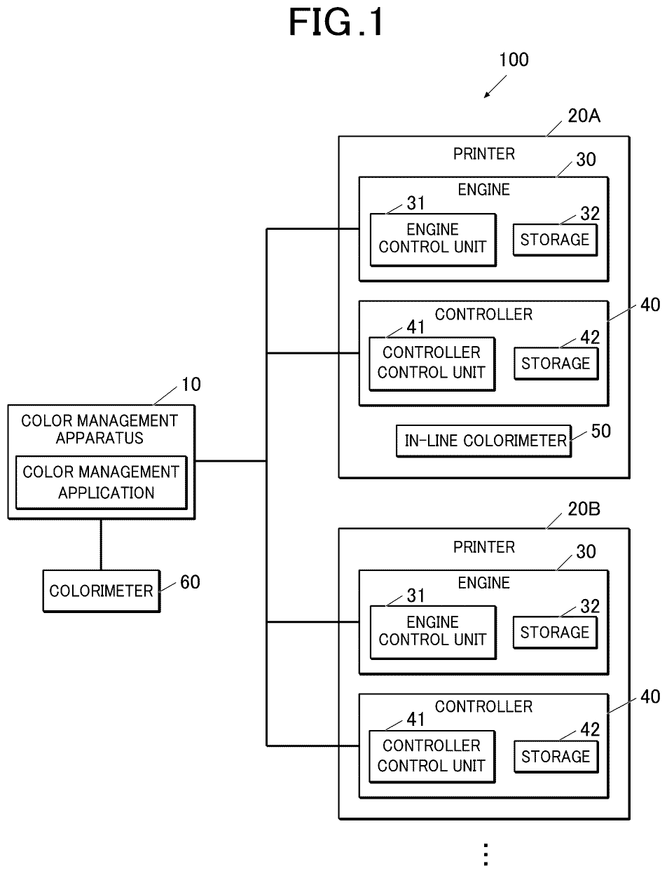

FIG. 1 is a system configuration diagram of a color management system 100 in the present embodiment. The color management system 100 includes a color management apparatus 10 as an external control apparatus, a plurality of printers 20A, 20B, . . . , and a colorimeter 60. The color management apparatus 10 and each of the plurality of printers 20A, 20B, . . . are data-communicably connected via a communication network such as a local area network (LAN). Hereinafter, each of the printers 20A, 20B, . . . will be referred to as the “printer 20” unless otherwise particularly distinguished.

The color management apparatus 10 is configured by a personal computer (PC) or the like. A program for a color management application is installed on the color management apparatus 10. The color management apparatus 10 holds information on the color management target setting (Target Configuration) of each printer 20, and manages the color of each printer 20.

The printer 20 prints an image on a sheet on the basis of image data of cyan (C), magenta (M), yellow (Y), and black (K).

The printer 20 includes an engine 30 (main body) and a controller 40. The printer 20 may include an in-line colorimeter 50. In FIG. 1, the printer 20A includes the in-line colorimeter 50, and the printer 20B does not include the in-line colorimeter 50.

The engine 30 includes one or more sheet feed trays. The engine 30 performs printing on a sheet fed from the sheet feed tray.

The engine 30 includes an engine control unit 31, a storage 32, and the like.

The engine control unit 31 controls each component of the engine 30. The engine control unit 31 has a color management and adjustment function of the engine 30.

The storage 32 stores various kinds of data related to the color management and adjustment function of the engine 30. For example, the storage 32 stores sheet information on the printer 20 including the engine 30, an adjustment value for the maximum density adjustment, an adjustment value for the density balance adjustment, and the like.

The controller 40 generates raster data to be provided to the engine 30. The controller 40 performs raster image processor (RIP) processing on print data created by various kinds of application software to convert the print data into the raster data.

The controller 40 includes a controller control unit 41, a storage 42, and the like.

The controller control unit 41 has a color management and adjustment function of the controller 40.

The storage 42 stores various kinds of data related to the color management and adjustment function of the controller 40. The storage 42 stores sheet information on the printer 20 including the controller 40, adjustment values (calibration values) for density adjustment for each sheet type, profiles for each sheet type, and the like.

The in-line colorimeter 50 is provided on a downstream side of a functional unit in which printing is performed in the engine 30 in a sheet conveyance path in the printer 20. The in-line colorimeter 50 measures a color of an image printed by the printer 20 and outputs colorimetric values (L*a*b* values or the like). The colorimeter 60 is connected to the color management apparatus 10 via a universal serial bus (USB) cable or the like. The colorimeter 60 measures a color of a patch group included in a chart printed by the printer 20 and outputs colorimetric values (L*a*b* values or the like).

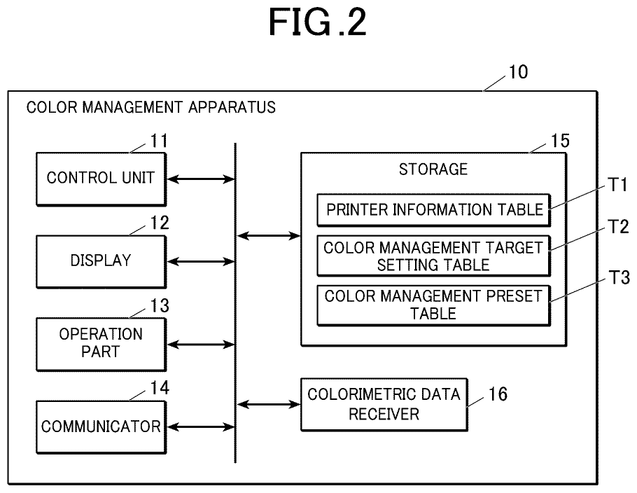

FIG. 2 is a block diagram illustrating a functional configuration of the color management apparatus 10. The color management apparatus 10 includes a control unit (hardware processor) 11, a display 12, an operation part 13, a communicator 14, a storage 15, and a colorimetric data receiver 16.

The control unit 11 includes a central processing unit (CPU), a random access memory (RAM), and the like. The control unit 11 comprehensively controls processing operation of each component of the color management apparatus 10. To be specific, the CPU reads various processing programs stored in the storage 15, loads the programs into the RAM, and performs various kinds of processing in cooperation with the programs.

The display 12 includes a monitor such as a liquid crystal display (LCD). The display 12 displays various screens according to an instruction of a display signal input from the control unit 11.

The operation part 13 includes a keyboard and a pointing device such as a mouse. The operation part 13 outputs, to the control unit 11, operation signals input through a key operation on the keyboard and an operation on the pointing device. In a case where the operation part 13 includes a touch screen laminated on the display 12, the operation part 13 outputs an operation signal corresponding to a position of a touch operation by a finger or the like of an operator to the control unit 11.

The communicator 14 is configured by a network interface or the like. The communicator 14 transmits and receives data to and from an external apparatus such as the printer 20 connected through a communication network.

The storage 15 includes a hard disk drive (HDD), a non-volatile memory, and the like. The storage 15 stores various processing programs and various types of data such as parameters and files that are necessary for the execution of the programs. For example, the storage 15 stores a program for a color management application, and the like. The color management application provides a user interface for performing an instruction to execute each color management and adjustment function of the printer 20, confirmation of a colorimetry result, input of an adjustment value, and the like. Furthermore, the color management application guides a user according to the order of the steps in each color management and adjustment function.

The storage 15 stores a printer information table T1, a color management target setting table T2, and a color management preset table T3.

The printer information table T1 is a table for managing printer information on the plurality of printers 20 in the color management system 100.

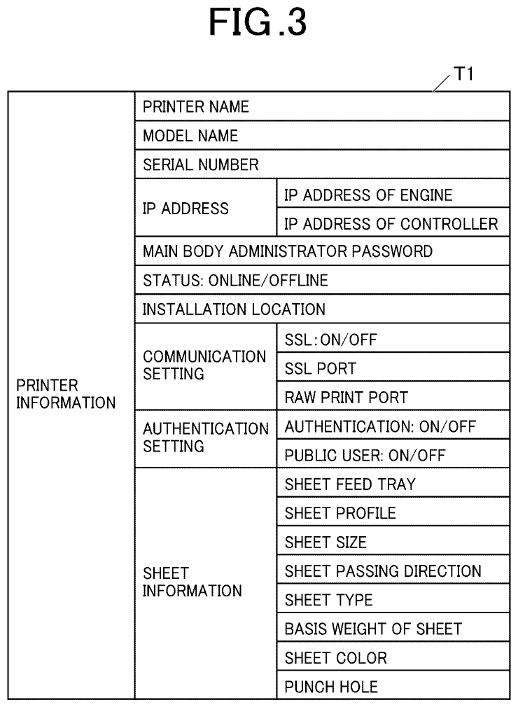

FIG. 3 illustrates an example of a data configuration of the printer information table T1. In the printer information table T1, a printer name, a model name, a serial number, an IP address, a main body administrator password, a status, an installation location, a communication setting, an authentication setting, sheet information, and the like are associated with each of the printers 20.

The “printer name” is a name of the printer 20.

The “model name” is a model name of the printer 20.

The “serial number” is a serial number of the printer 20.

The “IP address” includes an “IP address of an engine” and an “IP address of a controller”. The “IP address of an engine” is an example of engine information indicating the engine 30. The “IP address of a controller” is an example of controller information indicating the controller 40.

The “main body administrator password” is an administrator password of the main body (the engine 30) of the printer 20.

The “status” is information indicating the state of the printer 20. As the “status”, online or offline can be set.

The “installation location” is an installation location of the printer 20.

The “communication setting” is information indicating a communication setting of the printer 20. The “communication setting” includes SSL (ON or OFF), an SSL port, and a RAW print port.

The “authentication setting” is information indicating the authentication setting of the printer 20. The “authentication setting” includes authentication (ON or OFF) and a public user (ON or OFF).

The “sheet information” is information on the sheet to be used in the printer 20. The “sheet information” is information indicating the type of sheet, the sheet feed tray in which the sheet is loaded, and the like. The “sheet information” includes a sheet feed tray, a sheet profile, a sheet size, a sheet passing direction, a sheet type, a sheet basis weight, a sheet color, a punch hole, and the like.

The color management target setting table T2 is a table for managing a color management target setting (target configuration) used in the color management apparatus 10 (color management application).

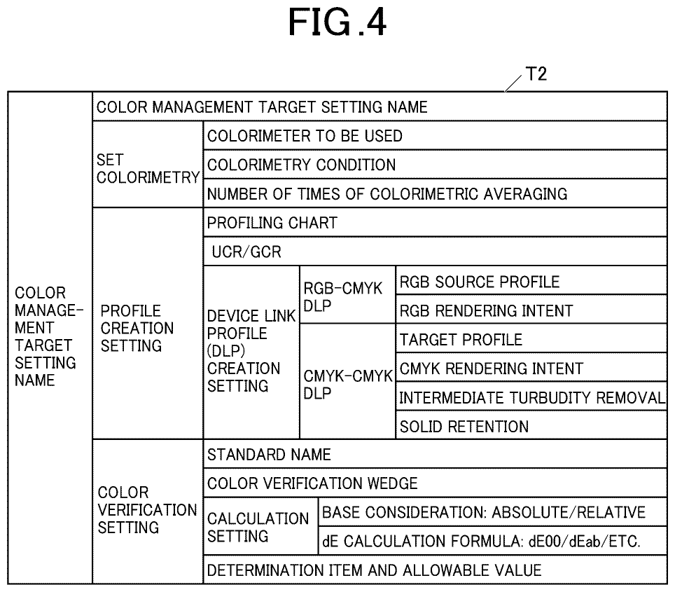

FIG. 4 illustrating an example of a data configuration of the color management target setting table T2. In the color management target setting table T2, a color management target setting name, a colorimetry setting, a profile creation setting, a color verification setting, and the like are associated with each color management target setting.

The “color management target setting name” is a name of the color management target setting.

The “colorimetry setting” is a setting related to the colorimetry. The “colorimetry setting” includes a colorimeter to be used, colorimetry conditions, and the number of times of colorimetric averaging.

When a colorimetric value is obtained, in consideration of stability during printing, a plurality of copies of a wedge or a chart are printed, and the colorimetric values are averaged for each patch. The “number of times of colorimetric averaging” is the number of copies of a wedge or a chart used for the averaging. The “number of times of colorimetric averaging” is a value specified by the user.

The “profile creation setting” is a setting related to creation of a profile. The “profile creation setting” includes a profiling chart, UCR/GCR, and a device link profile (DLP) creation setting.

The “profiling chart” is a chart used for creating a profile (profiling).

“Under color removal (UCR)” is to replace CMY in a shadow portion with a black plate (K). “Gray component replacement (GCR)” is to replace CMY of all gradation portions from a highlight portion to a shadow portion with a black plate (K). Basic ideas of the UCR and the GCR are the same.

The “DLP creation setting” includes RGB-CMYK DLP (RGB source profile, RGB rendering intent) and CMYK-CMYK DLP (target profile, CMYK rendering intent, intermediate haze removal, solid retention).

The “intermediate turbidity removal” is a setting for reproducing a color that is composed of only a single color before color conversion, so as to be composed of only that color also after color conversion. The “solid retention” is a setting for reproducing a solid portion before color conversion with a solid of the color also after color conversion.

The “color verification setting” is a setting related to the color verification setting. The “color verification setting” includes a standard name, a color verification wedge, a calculation setting, a determination item, and an allowable value.

The “calculation setting” includes underlayer consideration (absolute/relative) and a dE calculation formula (dE00, dEab, etc.).

The “determination item and allowable value” are a determination item and its allowable value defined by the standard. The “determination item and allowable value” are strictly set or loosely set according to the operation of the customer.

The color management preset (color management setting information) is information in which color management target setting, printer information, and sheet print setting information are associated with each other. The color management preset is a data set for color management.

The color management preset table T3 is a table for managing the color management preset.

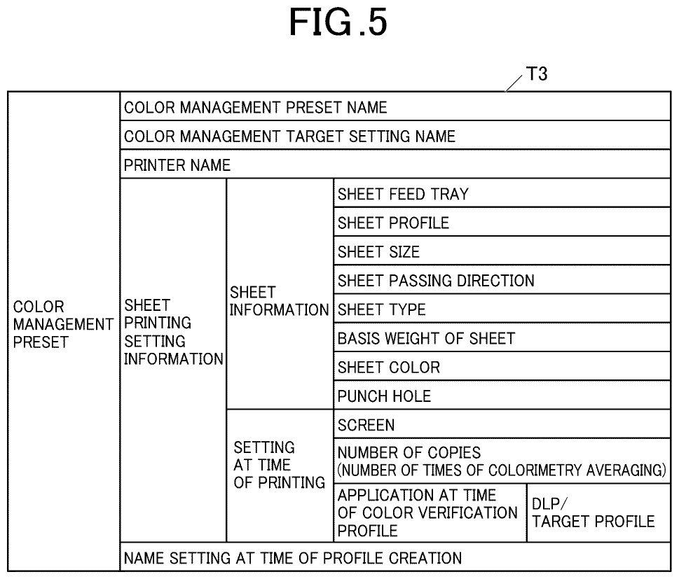

FIG. 5 illustrates an example of a data configuration of the color management preset table T3. In the color management preset table T3, a color management preset name, a color management target setting name, a printer name, sheet print setting information, a name setting at the time of creating a profile, and the like are associated with each color management preset.

The “color management preset name” is a name of the color management preset.

The “color management target setting name” is information for association with the “color management target setting” constituting the color management preset. Details of the “color management target setting” are acquired from the color management target setting table T2 on the basis of the “color management target setting name”.

The “printer name” is information for association with the “printer information” constituting the color management preset. Details of the “printer information” are acquired from the printer information table T1 on the basis of the “printer name”.

The “sheet print setting information” includes sheet information of a sheet to be subjected to the color management and a setting at the time of printing.

The “sheet information” includes a sheet feed tray, a sheet profile, a sheet size, a sheet passing direction, a sheet type, a sheet basis weight, a sheet color, a punch hole, and the like.

The “setting at the time of printing” includes a screen, the number of copies (the number of times of colorimetric averaging), a application profile at the time of color verification (DLP/target profile), and the like.

The “name setting at the time of creating a profile” includes a default name of each profile (printer profile, CMYK-CMYK DLP, RGB-CMYK DLP).

The colorimetric data receiver 16 receives colorimetric values (such as L*a*b* values) from the colorimeter 60.

The control unit 11 controls the color management of each printer 20 connected through the communication network in cooperation with the program of the color management application. The control unit 11 performs the color management of the printer 20 including two elements, the engine 30 and the controller 40.

The control unit 11 has a printer management function. The control unit 11 holds information of the engine and the controller 20 so as to be connectable to the engine 30 and the controller 40 of the printer 20. The control unit 11 performs confirmation of connection availability status to each of the engine 30 and the controller 40, an adjustment instruction to each of the engine 30 and the controller 40, a print instruction of a wedge or a chart, a colorimetry instruction to the in-line colorimeter 50, registration of the created profile, and the like.

The control unit 11 searches for the printer 20 in the communication network and acquires the printer information of the printer 20. To be specific, the control unit 11 searches for the engine 30 and the controller 40 of the printer 20 in the same network as the color management apparatus 10. The control unit 11 acquires the printer information from the engine 30 or the controller 40 and manages the acquired printer information. The printer information includes an IP address of the engine 30, an IP address of the controller 40, a printer name, a serial number, sheet information, and the like.

The control unit 11 controls the color management and adjustment function of the engine 30 and the color management and adjustment function of the controller 40 from the outside of the printer 20.

The control unit 11 controls the color management and adjustment function of the engine 30 and the color management and adjustment function of the controller 40 on the basis of the color management preset (color management setting information).

The control unit 11 accepts specification of sheet print setting information included in the color management preset (color management setting information) stored in the storage 15. That is, the control unit 11 functions as an acceptor.

The control unit 11 controls the color management and adjustment function of the engine 30 and the color management and adjustment function of the controller 40 on the basis of the color management target setting associated with the specified sheet print setting information.

The color management and adjustment function of the engine 30 includes an adjustment function related to the maximum density of an image printed by the engine 30 or an adjustment function related to the density balance. The color management and adjustment function of the engine 30 may include an adjustment function related to the density (calibration function).

The color management and adjustment function of the controller 40 includes an adjustment function (calibration function) related to the density of an image to be printed by the engine 30 corresponding to the controller 40 for each sheet type, or a profile creation function.

The control unit 11 acquires, from the controller 40, the sheet information managed by the controller 40. The control unit 11 updates the sheet information acquired from the controller 40 as a part of the printer information including the controller information indicating the controller 40 stored in the storage 15.

When the control unit 11 cannot acquire, from the controller 40, the sheet information managed by the controller 40, the control unit 11 acquires, from the engine 30, the sheet information managed by the engine 30. The control unit 11 updates the sheet information acquired from the engine 30 as part of the printer information including the engine information indicating the engine 30 stored in the storage 15.

The color management system 100 may include a dedicated sheet management apparatus that manages the sheet information of each printer 20 and is provided outside the printer 20. For example, the dedicated sheet management apparatus manages a printer name and sheet information in association with each other for each printer 20. In this case, the control unit 11 acquires the sheet information from the dedicated sheet management apparatus in preference to the controller 40 or the engine 30.

The control unit 11 acquires the sheet information related to the printer 20 from an external apparatus (dedicated sheet management apparatus) other than the engine 30 and the controller 40. The control unit 11 updates the acquired sheet information as a part of the printer information including the engine information indicating the engine 30 or the controller information indicating the controller 40 stored in the storage 15.

The control unit 11 acquires the latest sheet information from the engine 30 or the controller 40 immediately before the color management and adjustment of the engine 30 or the color management and adjustment of the controller 40. When the sheet to be subjected to the color management and adjustment is not set in any sheet feed tray of the printer 20, the control unit 11 stops the execution of the color management and adjustment, and issues an error notification indicating that the sheet to be subjected to the color management and adjustment is not set.

The sheet information includes a list of one or more sheet feed trays included in the printer 20 and information indicating the sheet type and sheet passing direction for each of the sheet feed trays.

The control unit 11 executes the color verification function with respect to the printer 20. To be specific, the control unit 11 causes the engine 30 of the target printer 20 to print a color verification chart on the basis of the color management target setting associated with the printer 20. The control unit 11 acquires the colorimetric value of each patch in the printed chart. The control unit 11 determines whether the color printed by the printer 20 satisfies the color management target setting on the basis of the acquired colorimetric value (color verification). For example, the control unit 11 determines whether the value calculated for each determination item is equal to or smaller than an allowable value on the basis of the colorimetric value.

The control unit 11 notifies the user of the determination result of the color verification.

### [Operation of Color Management System]

Next, operations in the color management system 100 will be described.

### (Printer Information Registration)

First, registration of printer information will be described.

The user registers the printer 20 owned by the company to which the user belongs or the user himself or herself on the color management application in the color management apparatus 10.

When the user issues an instruction to start the registration of the printer information through an operation on the operation part 13, the control unit 11 of the color management apparatus 10 searches for the target printer 20 from the same network. The control unit 11 causes the display 12 to display a list of the printers 20 in the same network as a search result.

The user selects a printer 20 to be registered from the list of the printers 20 through an operation on the operation part 13. The control unit 11 acquires information from the engine 30 and the controller 40 of the selected printer 20 via the communicator 14, and causes the display 12 to display the acquired information. For example, the control unit 11 acquires, from the engine 30 or the controller 40, the IP address of the engine 30, the IP address of the controller 40, the serial number of the printer 20, the installation location, the sheet information, the communication setting, the authentication setting, and the like.

At this time, basically, the control unit 11 acquires the sheet information stored in the storage 42 from the controller 40 via the communicator 14. The sheet information includes information of a sheet feed tray included in the printer 20 and information of a sheet set in each sheet feed tray (a sheet profile, a sheet size, a sheet passing direction, a sheet type, a sheet basis weight, a sheet color, a punch hole, and the like). However, when the control unit 11 cannot acquire the sheet information from the controller 40, the control unit 11 acquires the sheet information stored in the storage section 32 from the engine 30 via the communicator 14.

The sheet information is acquired in advance for future use. Therefore, the control unit 11 does not cause the display 12 to display the sheet information at this time point. Note that the control unit 11 may cause the display 12 to display the sheet information at this timing and cause the user to confirm the sheet information.

Next, the control unit 11 causes the display 12 to display a printer information registration screen.

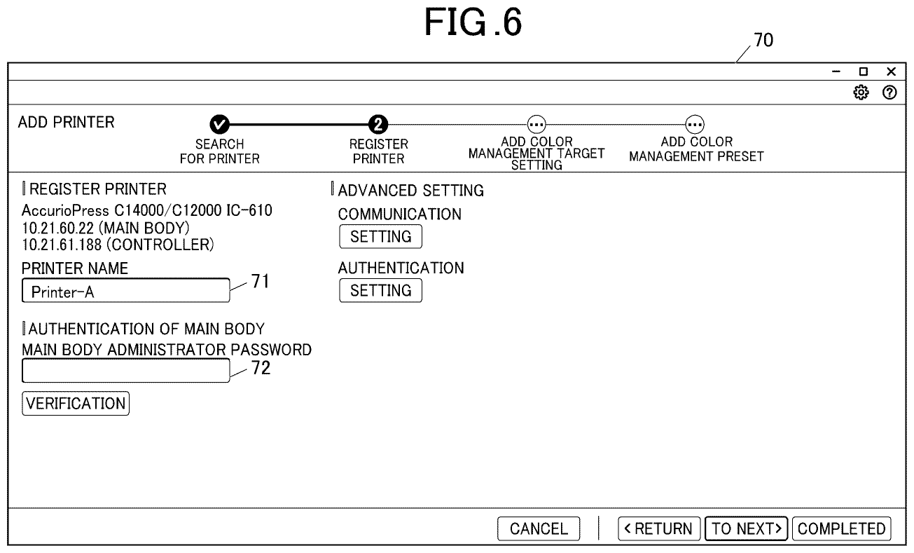

FIG. 6 illustrates an example of a printer information registration screen 70. The printer information registration screen 70 includes a printer name input field 71, an administrator password input field 72, and the like.

The user inputs additionally necessary items (a printer name, a administrator password, and the like) through operations on the operation part 13.

The control unit 11 associates the information acquired from the engine 30 or the controller 40 with the information input by the user, and registers the information with the printer information table T1 of the storage 15. Thus, the registration of the printer information is completed.

### (Color Management Target Setting)

Next, the user registers color management target setting (target configuration) on the color management application. The color management target setting defines, based on standards and the like, a colorimetry setting, a color verification setting, and a profile creation setting, as to how a customer performs the color management.

When the user issues an instruction to add a color management target setting through an operation on the operation part 13, the control unit 11 causes the display 12 to display a colorimetry setting screen.

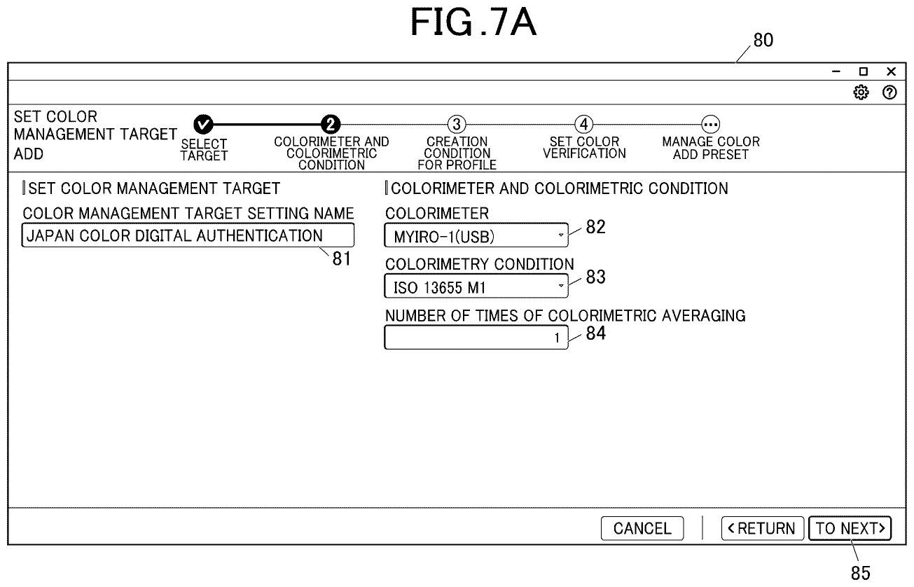

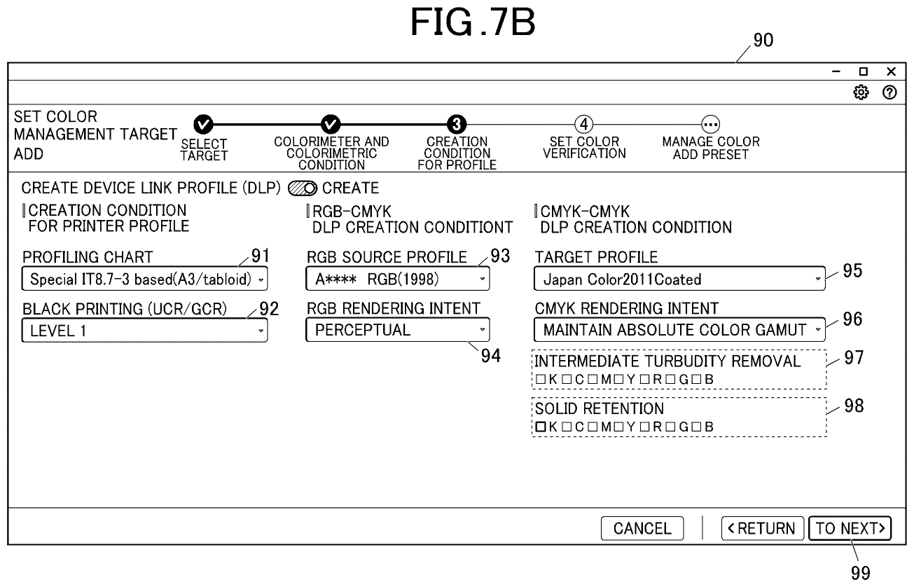

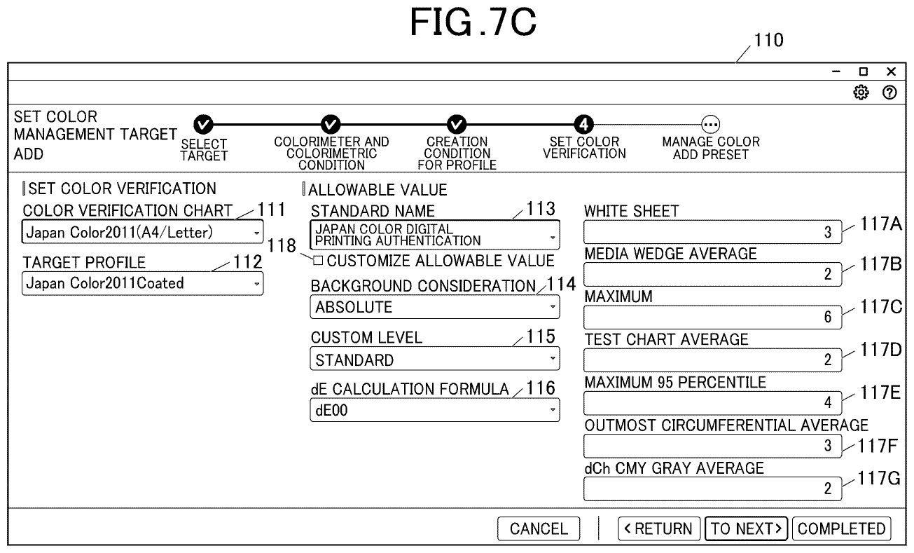

FIG. 7A illustrates an example of a colorimetry setting screen 80. The colorimetry setting screen 80 includes a color management target setting name input field 81, a colorimeter selection field 82, a colorimetry condition selection field 83, a number of times of colorimetric averaging input field 84, a next button 85, and the like.

The user sets various information such as a color management target setting name, a colorimeter, a colorimetry condition, and the number of times of colorimetric averaging, through operations on the operation part 13.

When the user presses the next button 85 on the colorimetry setting screen 80 through an operation on the operation part 13, the control unit 11 causes the display 12 to display a profile creation setting screen.

FIG. 7B illustrates an example of a profile creation setting screen 90. The profile creation setting screen 90 includes a profiling chart selection field 91, a UCR/GCR selection field 92, an RGB source profile selection field 93, an RGB rendering intent selection field 94, a target profile selection field 95, a CMYK rendering intent selection field 96, an intermediate turbidity removal selection field 97, a solid retention selection field 98, a next button 99, and the like.

The user sets various information such as a profiling chart, a UCR/GCR, an RGB-CMYK DLP creation condition, and a CMYK-CMYK DLP creation condition through operations on the operation part 13.

When the user presses the next button 99 on the profile creation setting screen 90 through an operation on the operation part 13, the control unit 11 causes the display 12 to display a color verification setting screen.

FIG. 7C illustrates an example of a color verification setting screen 110. The color verification setting screen 110 includes a color verification chart selection field 111, a target profile selection field 112, a standard name selection field 113, a base color consideration selection field 114, a custom level selection field 115, a dE calculation formula selection field 116, allowable value input fields 117A to 117G for respective determination items, a check box 118, and the like. The check box 118 is checked to customize the allowable values. When the user checks the check box 118 and selects “custom” in the custom level selection field 115, each allowable value can be changed.

The user sets various information such as a color verification chart (color verification wedge), a target profile, a standard name, a calculation setting (base consideration, dE calculation formula), and allowable values, through operations on the operation part 13.

The user issues an instruction to complete the registration of the color management target setting through an operation on the operation part 13. Then, the control unit 11 registers, with the color management target setting table T2 in the storage 15, the information set on the colorimetry setting screen 80, the profile creation setting screen 90, and the color verification setting screen 110 in association with each other. Thus, the registration of the color management target setting is completed.

### (Color Management Preset Setting)

Finally, the user sets the color management preset on the color management application. The color management preset is used to adjust the color of the printer 20 according to the color management target setting and perform color management. The color management preset is a data set for managing the printer 20, the color management target setting, and the sheet print setting information in association with each other.

When the user issues an instruction to add a color management preset through an operation on the operation part 13, the control unit 11 causes the display 12 to display a color management preset registration screen.

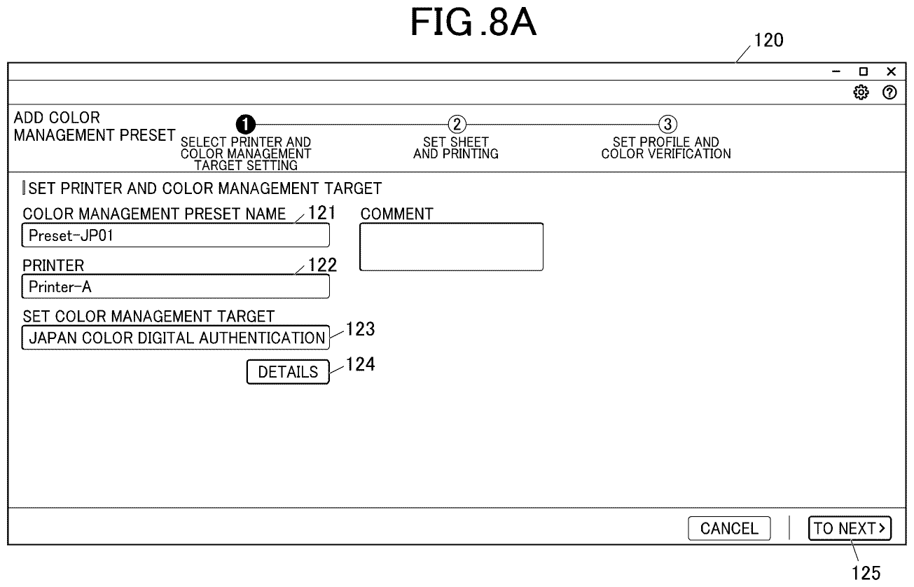

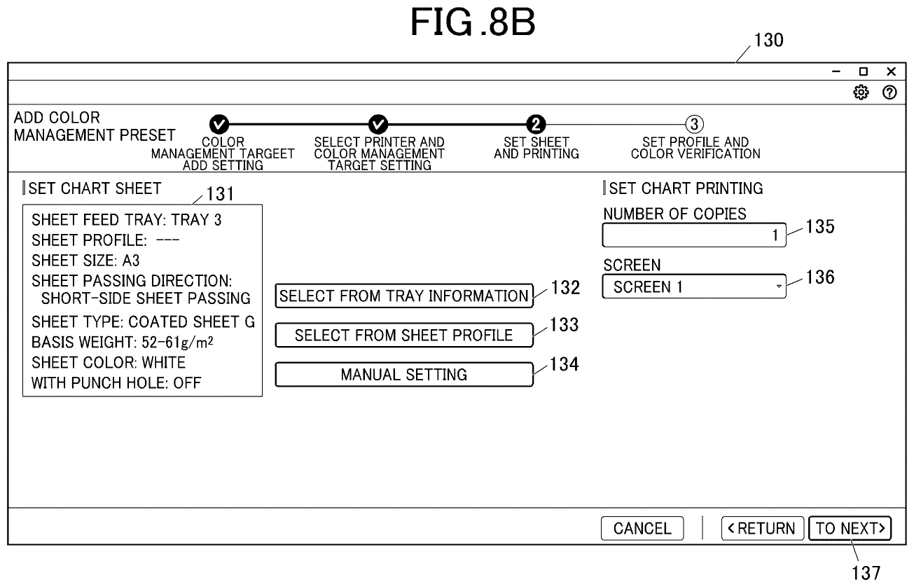

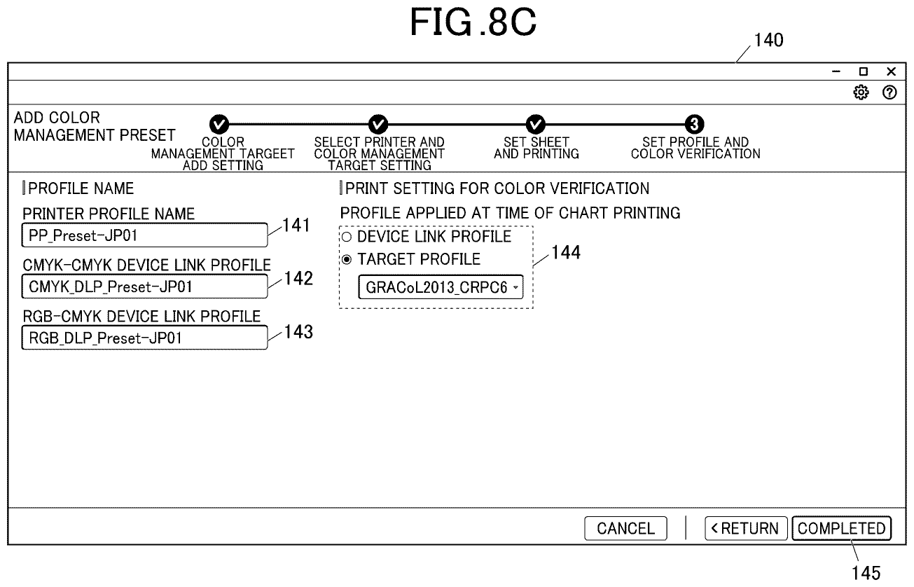

FIG. 8A illustrates an example of a color management preset registration screen 120. The color management preset registration screen 120 includes a color management preset name input field 121, a printer selection field 122, a color management target setting selection field 123, a detail button 124, a next button 125, and the like.

The user inputs the color management preset name through an operation on the operation part 13, and selects the registered printer 20 and the color management target setting. The control unit 11 acquires the printer information corresponding to the selected printer 20 from the printer information table T1 in the storage 15. The control unit 11 acquires various information of the selected color management target setting from the color management target setting table T2 in the storage 15.

Note that when the detail button 124 is pressed, the content of the selected color management target setting is displayed.

When the user presses the next button 125 on the color management preset registration screen 120 through an operation on the operation part 13, the control unit 11 causes the display 12 to display a sheet print setting screen.

FIG. 8B illustrates an example of a sheet print setting screen 130. The sheet print setting screen 130 includes a chart sheet information display field 131, a tray selection button 132, a sheet profile selection button 133, a manual setting button 134, a number-of-copies input field 135, a screen selection field 136, a next button 137, and the like.

The sheet information of the sheet on which the chart is printed is displayed in the chart sheet information display field 131. The chart is an adjustment chart, a profiling chart, a color verification wedge, or the like.

When the tray selection button 132 is pressed, the sheet information associated with each sheet feed tray of the printer 20 selected in the printer selection field 122 (see FIG. 8A) is acquired from the printer information table T1 and is displayed. The user can set the sheet information on the chart sheet by selecting any one from the displayed pieces of sheet information.

When the sheet profile selection button 133 is pressed, the sheet information associated with the sheet profile of the printer 20 selected in the printer selection field 122 is acquired from the printer information table T1 and is displayed. The user can set the sheet information on the chart sheet by selecting any one from the displayed pieces of sheet information.

When the manual setting button 134 is pressed, a setting screen for the sheet information is displayed. The user can set the sheet information on the chart sheet by selecting each item in the setting screen.

Note that the control unit 11 can automatically determine whether the sheet is a coated sheet or a plain sheet according to the “target profile” included in the “color management target setting” selected in the color management target setting selection field 123 (see FIG. 8A). In addition, the control unit 11 can automatically determine whether the sheet size is A3/Tabloid or A4/Letter according to the “color verification wedge”. On the basis of these determination results, the control unit 11 may automatically specify the sheet feed tray in which the suitable sheets are set.

A value associated with the number of times of color colorimetric averaging is set in the number-of-copies input field 135.

The user selects a screen for the setting at the time of printing in the screen selection field 136 through an operation on the operation part 13.

The information set on the sheet print setting screen 130 is registered as the “sheet information” or “setting at the time of printing” of the “sheet print setting information” constituting the color management preset.

When the user presses the next button 137 on the sheet print setting screen 130 through an operation on the operation part 13, the control unit 11 causes the display 12 to display a profile name setting screen.

FIG. 8C illustrates an example of a profile name setting screen 140. The profile name setting screen 140 includes a printer profile name input field 141, a CMYK-CMYK devices link profile input field 142, an RGB-CMYK devices link profile input field 143, an application profile selection field at the time of color verification 144, a complete button 145, and the like.

The user inputs a default name of each profile (a printer profile, a CMYK-CMYK device link profile, and an RGB-CMYK device link profile) at the time of profile creation through an operation on the operation part 13. The user selects a profile (a device link profile or a target profile) to be applied at the time of color verification through an operation on the operation part 13.

The user presses the completion button 145 on the profile name setting screen 140 through an operation on the operation part 13. Then, the control unit 11 registers, with the color management preset table T3 in the storage 15, the information set on the color management preset registration screen 120, the sheet print setting screen 130, and the profile name setting screen 140 in association with each other. Thus, the registration of the color management preset is completed.

With the registration of the color management preset, the color management apparatus 10 is ready for color management. Subsequently, a specific example of color adjustment will be described.

The control unit 11 causes the display 12 to display a list of the printers 20 registered with the printer information table T1 in the storage 15. At this time, the control unit 11 checks the connection status (online/offline) of each printer 20, and causes the status field on the list to display the connection status. In addition, the control unit 11 grays out the printer 20 of which the connection status is “offline” on the list so that the printer 20 cannot be selected as a target of color management.

When the user selects one of the printers 20 as a color management target from the list screen, the control unit 11 causes the display 12 to display a menu screen. The menu screen is a screen on which tools for color adjustment and color management are arranged. At this time, the control unit 11 acquires the latest sheet information from the selected printer 20 and updates the sheet information corresponding to the printer 20 in the printer information table T1.

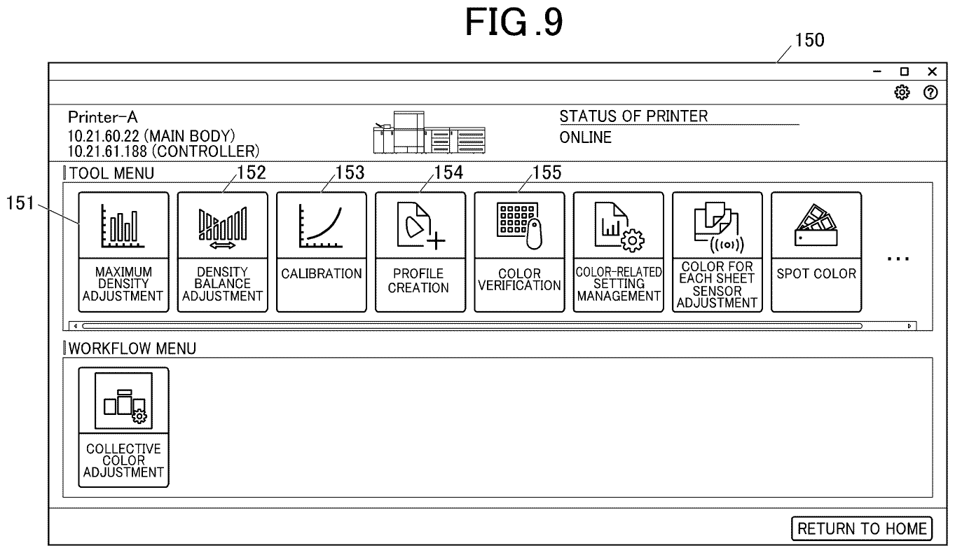

FIG. 9 illustrates an example of a menu screen 150. The menu screen 150 includes a “maximum density adjustment” icon 151, a “density balance adjustment” icon 152, a “calibration” icon 153, a “profile creation” icon 154, a “color verification” icon 155, and the like.

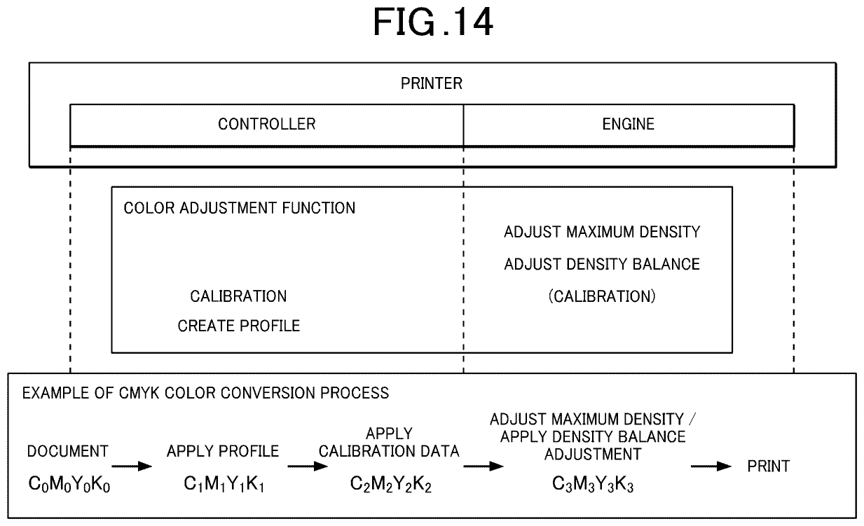

As described with reference to FIG. 14, in the color adjustment, first, the engine 30 which is the base is adjusted, and next, the controller 40 is adjusted. Therefore, there is a basic order for color adjustment. As the basic fixing, the maximum density of each color solid of CMYK is adjusted for the engine 30, and next, the density balance (unevenness in the sheet surface) is adjusted so that the density can be maintained in the entire sheet. Subsequently, calibration (density adjustment) for each standard and each sheet type and creation of each profile are performed on the controller 40. The calibration includes adjustment for daily variation.

### (Maximum Density Adjustment)

First, the maximum density adjustment (Maximum Density) will be described.

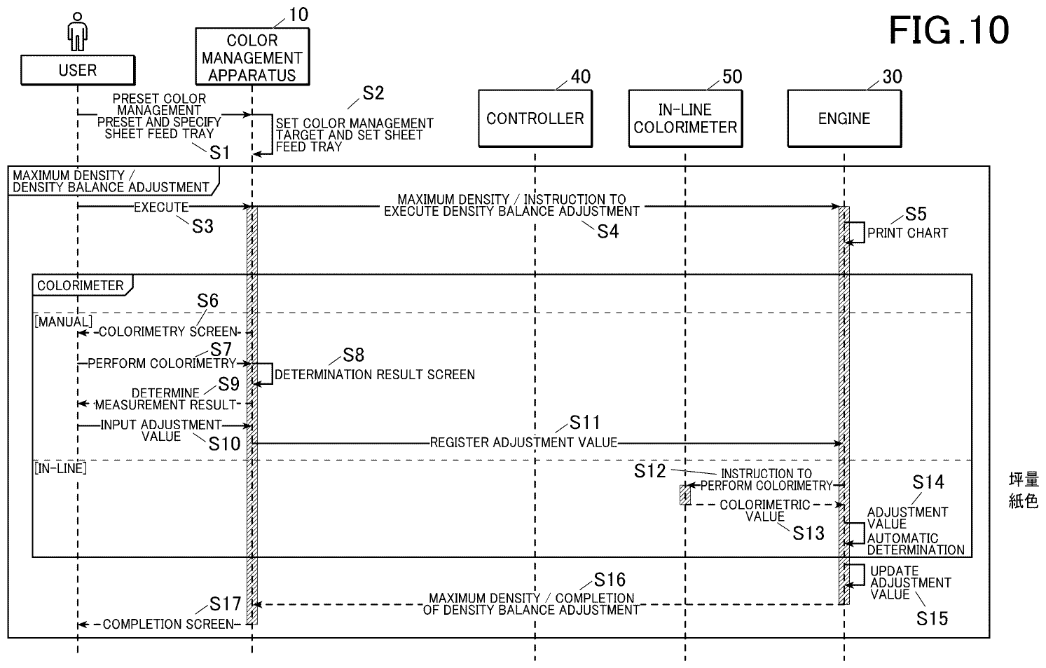

FIG. 10 is a sequence diagram at the time of executing the maximum density adjustment or the density balance adjustment.

When the user presses the “maximum density adjustment” icon 151 on the menu screen 150 (see FIG. 9) on the color management application, the control unit 11 causes the display 12 to display a sheet feed tray selection screen for the printer 20 to be subjected to the color management.

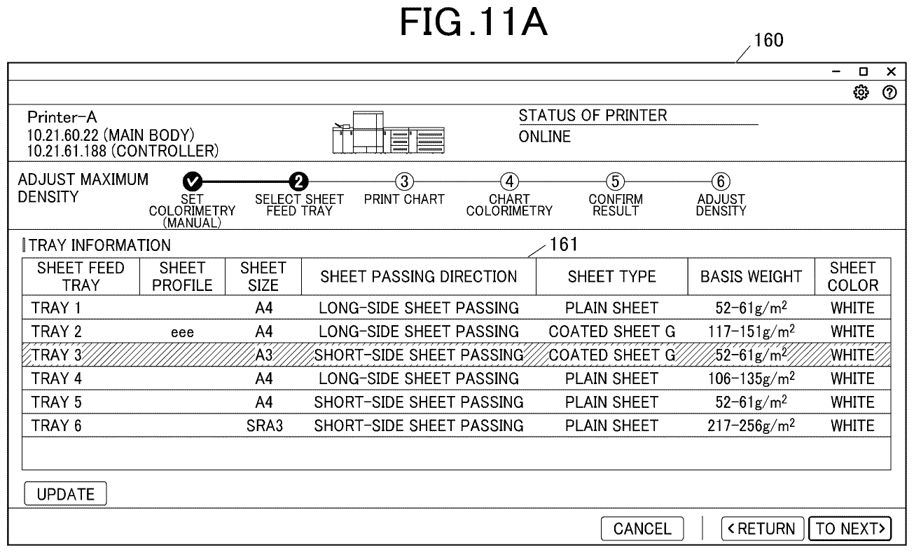

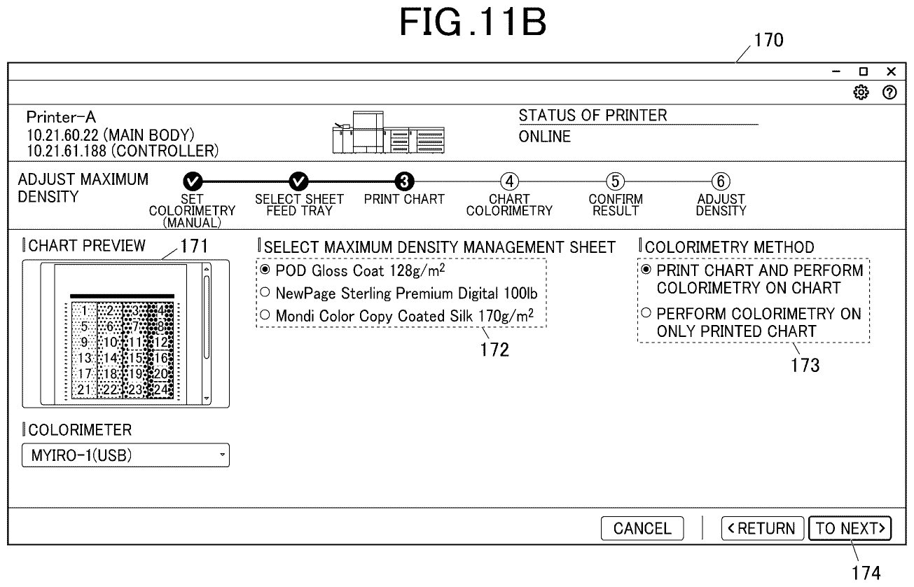

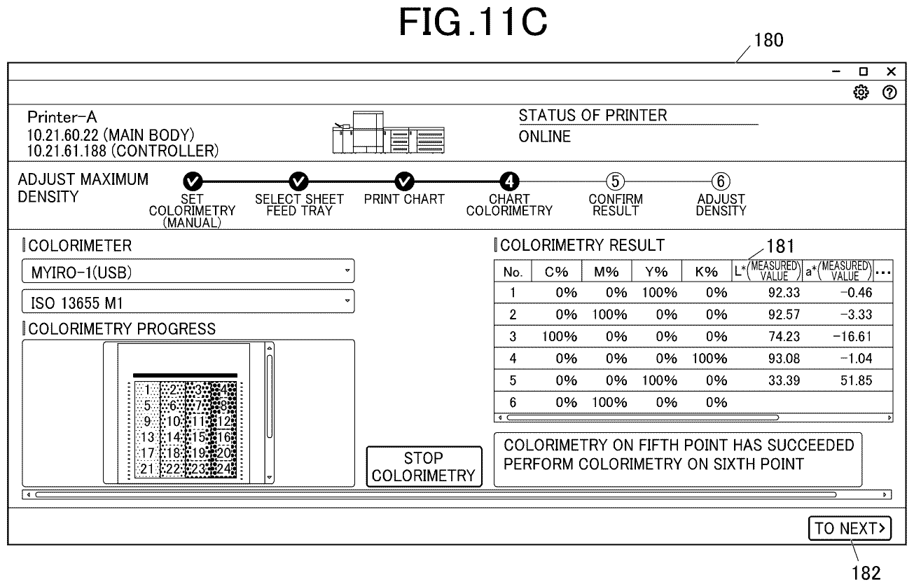

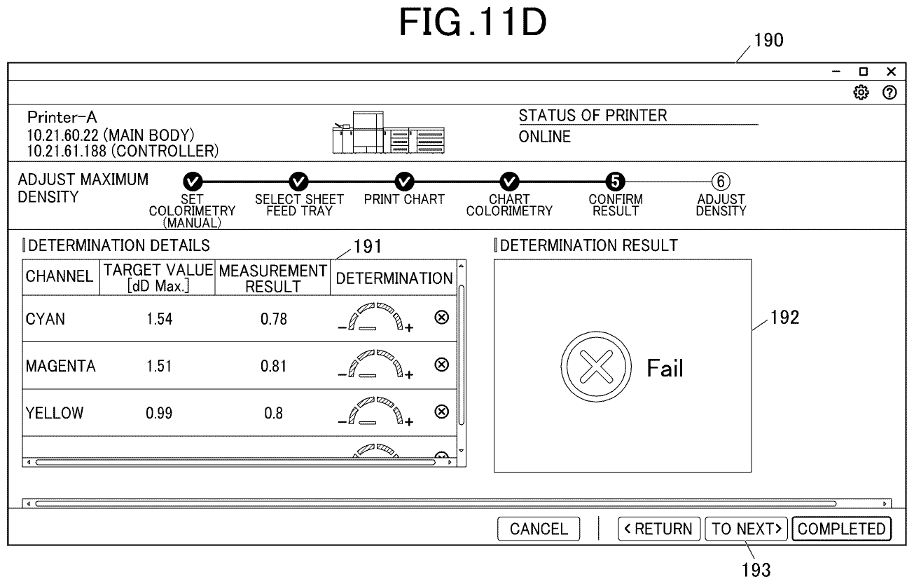

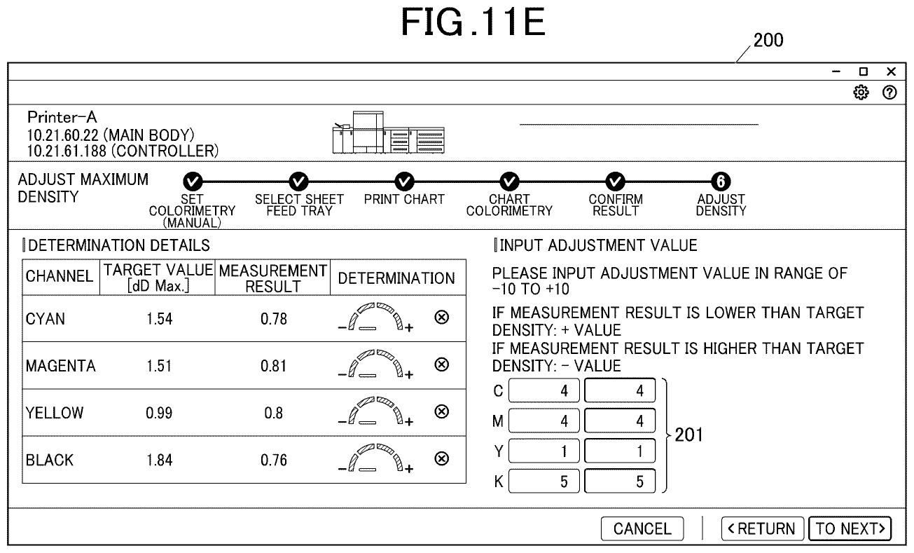

FIG. 11A illustrates an example of a sheet feed tray selection screen 160. The sheet feed tray selection screen 160 includes a sheet feed tray list field 161 and the like. The control unit 11 refers to the printer information table T1 in the storage 15 and causes the sheet feed tray list field 161 to display, for each sheet feed tray, the sheet information corresponding to the printer 20 to be subjected to the color management. The control unit 11 also refers to the color management preset table T3 in the storage 15 to specify a color management preset corresponding to the printer 20 to be subjected to the color management. That is, the designation of the printer 20 to be subjected to the color management by the user corresponds to the designation of the color management preset.

In the sheet feed tray list field 161, the most suitable option (sheet feed tray) is automatically selected on the basis of the “sheet print setting information” set in the “color management preset” by default.

At this time, the control unit 11 acquires the latest sheet information from the engine 30 or the controller 40 included in the printer 20 to be subjected to the color management via the communicator 14. The control unit 11 determines whether the sheet to be subjected to the color management and adjustment is set in the sheet feed tray included in the printer 20 to be subjected to the color management target on the basis of the acquired sheet information. When the suitable sheet is not set in any sheet feed tray of the printer 20, the control unit 11 stops the execution of the color management and adjustment (maximum density adjustment). In this case, the control unit 11 causes the display 12 to display an error message indicating that the sheet to be subjected to the color management and adjustment is not set. In this way, the control unit 11 alerts the user by providing notification of an error. The sheet feed tray list field 161 shows the sheet information (a sheet profile, a sheet size, a sheet passing direction, a sheet type, a basis weight, and a sheet color) on the sheets set in each sheet feed tray. The user can confirm the sheet information of the sheets set in each sheet feed tray. Note that the display of the sheet information in the sheet feed tray list field 161 may be omitted.

The user designates a sheet feed tray from the sheet feed tray list field 161 through an operation on the operation part 13 (Step S1). In addition, the color management preset to be used here is determined (equivalent to “designation of color management preset”).

To be specific, in a case where only one color management preset is set for the printer 20 to be subjected to the color management, since the sheet information (a sheet type or the like) is also uniquely determined, the corresponding sheet feed tray is automatically selected in the sheet feed tray list field 161.

In a case where a plurality of color management presets are set for the printer 20 to be subjected to the color management, when the sheet information (a sheet type or the like) of the sheets which are set in the sheet feed tray is only one, conversely, the color management preset is uniquely determined automatically from the designated sheet feed tray.

In a case where a plurality of color management presets are set for the printer 20 to be subjected to the color management, when sheets having a plurality of pieces of sheet information (sheet types or the like) are set in the sheet feed trays, the user selects a sheet feed tray from the sheet feed tray list field 161. The color management preset is determined from the printer 20 to be subjected to the color management and the sheet print setting information specified by the selected sheet feed tray.

In a case where a sheet feed tray can be automatically selected in the sheet feed tray list field 161 on the sheet feed tray selection screen 160 illustrated in FIG. 11A, a sheet feed tray is automatically selected according to the above-described rule. On the other hand, in a case where the sheet feed tray cannot be automatically selected, the user is prompted to manually select a sheet feed tray in the sheet feed tray list field 161 on the sheet feed tray selection screen 160, and the process proceeds to the next step.

The control unit 11 sets the designated sheet feed tray as the sheet feed tray in which the sheet to be subjected to the color management is set (Step S2). The control unit 11 also acquires, from the color management preset corresponding to the printer 20 to be subject to the color management, the “color management target setting” corresponding to the “sheet print setting information” including the specified sheet feed tray. That is, the control unit 11 controls the color management and adjustment function of the engine 30 on the basis of the color management target setting associated with the sheet feed tray (sheet print setting information) specified by the user.

Next, the control unit 11 causes the display 12 to display a chart print screen.

FIG. 11B illustrates an example of a chart print screen 170. The chart print screen 170 includes a chart preview field 171, a sheet selection field 172, a colorimetry method selection field 173, and the like.

A preview of a chart for maximum density adjustment is displayed in the chart preview field 171.

In the sheet selection field 172, a sheet to be used for the maximum density adjustment is selected.

In the colorimetry method selection field 173, whether to print a chart and perform colorimetry or to perform colorimetry on the printed chart is selected.

The user selects a sheet and a colorimetry method in the chart print screen 170.

The user presses the next button 174 on the chart print screen 170 to issue an instruction to execute the maximum density adjustment (Step S3).

The control unit 11 transmits the instruction to execute the maximum density adjustment to the engine 30 via the communicator 14 (Step S4). The instruction to execute the maximum density adjustment includes specification of a chart and an instruction to print the chart. The control unit 11 transmits, to the engine 30, the instruction to execute the maximum density adjustment according to the “color management target setting” and the “sheet print setting information” included in the “color management preset”.

The engine control unit 31 of the engine 30 controls each component of the engine 30 to print a chart for maximum density adjustment (Step S5). The chart for maximum density adjustment includes a patch of solid density of each color of CMYK. Note that no chart is printed when colorimetry of the printed chart is selected in the colorimetry method selection field 173.

Next, the control unit 11 causes the display 12 to display a colorimetry screen (Step S6).

FIG. 11C illustrates an example of a colorimetry screen 180. The colorimetry screen 180 includes a colorimetry result field 181, a next button 182, and the like.

The user performs the colorimetry on each patch of the chart for maximum density adjustment with the colorimeter 60 (Step S7). Note that as the colorimeter 60 to be used for colorimetry, the “colorimeter” set in the “colorimetry setting” of the “color management target setting” is selected by default.

The control unit 11 is connected to the colorimeter 60 via the colorimetric data receiver 16, and receives a colorimetry result (a colorimetric value and a density value) from the colorimeter 60. The control unit 11 causes the colorimetry result field 181 on the colorimetry screen 180 to display the colorimetry result of each patch.

Furthermore, the control unit 11 may transmit the colorimetry result to the printer 20 (engine 30) via the communicator 14.

The user checks the colorimetric value, and if there is no problem, presses the next button 182 on the colorimetry screen 180.

In response to the pressing of the next button 182, the control unit 11 determines, for each of the CMYK colors, whether the measurement result of the maximum density satisfies a predetermined criterion (Step S8).

The control unit 11 causes the display 12 to display a determination result screen (Step S9).

FIG. 11D illustrates an example of the determination result screen 190. The determination result screen 190 includes a determination details field 191, a comprehensive determination result field 192, a next button 193, and the like.

The determination details field 191 includes a comparison result between the target value (dD Max.) and the measurement result (density value) for each color of CMYK and a determination result for each color. The target value is determined in advance for each sheet type.

In the comprehensive determination result field 192, “Fail” or “Pass” is displayed as the comprehensive determination result.

When the user presses the next button 193 on the determination result screen 190 through an operation on the operation part 13, the control unit 11 causes the display 12 to display an adjustment screen.

FIG. 11E illustrates an example of the adjustment screen 200. The adjustment screen 200 includes an adjustment value input field 201 and the like.

The user adjusts the concentration setting of the engine 30 on the basis of the determination result. The user inputs an adjustment value to the adjustment value input field 201 for each color of CMYK through an operation on the operation part 13 (Step S10).

The control unit 11 transmits an instruction to register the adjustment value of the maximum density adjustment to the engine 30 via the communicator 14 (Step S11).

If the previous determination result is “Fail”, the control unit 11 of the color management apparatus 10 instructs the engine 30 to start the execution of the maximum density adjustment again, and repeats this operation until all colors become “Pass”.

The engine control unit 31 of the engine 30 causes the storage section 32 to store the adjustment value for the maximum density adjustment transmitted from the color management apparatus 10, and updates the adjustment value (Step S15).

Here, the case where the user manually inputs the adjustment value has been described, but the control unit 11 (color management application) may automatically predict the adjustment value and set the adjustment value.

On the other hand, when the printer 20 includes the in-line colorimeter 50, the following processes are performed instead of the processes of Steps S6 to S11.

After the chart is printed by the engine 30 (Step S5), the engine control unit 31 of the engine 30 instructs the in-line colorimeter 50 to perform colorimetry (Step S12). As the in-line colorimeter 50 used for colorimetry, the “colorimeter” set in the “colorimetry setting” of the “color management target setting” is selected by default.

The in-line colorimeter 50 performs colorimetry on each patch of the chart for maximum density adjustment. The engine control unit 31 of the engine 30 acquires a colorimetry result (a colorimetric value and a density value) from the in-line colorimeter 50 (Step S13).

The engine control unit 31 of the engine 30 compares the measured density with the target value for each color of CMYK, and automatically determines the adjustment value (Step S14).

The engine control unit 31 causes the storage 32 to store the determined adjustment value of the maximum density adjustment, and updates the adjustment value (Step S15).

After Step S15, the engine control unit 31 of the engine 30 transmits, to the color management apparatus 10, information indicating that the maximum density adjustment has been completed (Step S16).

The control unit 11 of the color management apparatus 10 causes the display 12 to display a completion screen of the maximum density adjustment (Step S17).

Note that even when the printer 20 includes the in-line colorimeter 50, the control unit 11 of the color management apparatus 10 may acquire the colorimetry result from the printer 20 and cause the display 12 to display the colorimetry result. Furthermore, the control unit 11 may automatically determine the adjustment value by comparing the measured density with the target value for each color of CMYK.

### (Density Balance Adjustment)

Next, the density balance adjustment will be described.

Also in the density balance adjustment, the flow of the adjustment is roughly similar to that of the maximum density adjustment (see FIG. 10). Here, the case of manual colorimetry will be described.

When the user presses the “density balance adjustment” icon 152 on the menu screen 150 (see FIG. 9) on the color management application, the control unit 11 causes the display 12 to display a colorimeter and a screen setting screen. In the setting screen, the default value of the colorimeter is the “colorimeter” included in the “colorimetry setting” of the “color management target setting” of the “color management preset” corresponding to the printer 20 to be subjected to the color management. In the setting screen, the default value of the screen is the “screen” included in the “setting at the time of printing” of the “sheet print setting information” of the “color management preset”.

The user changes the colorimeter and the screen through an operation on the operation part 13 as necessary.

Subsequently, as in the case of the maximum density adjustment, the control unit 11 accepts selection of a sheet feed tray by the user and causes a preview of a chart for density balance adjustment to be displayed. The control unit 11 may accept selection of a chart from among a plurality of types of charts.

Upon receiving a print instruction for a chart, the control unit 11 transmits an instruction to execute density balance adjustment to the engine 30 via the communicator 14. The instruction to execute the density balance adjustment includes specification of a chart and an instruction to print the chart.

The engine control unit 31 of the engine 30 controls each component of the engine 30 to print a chart for density balance adjustment. In the chart for density balance adjustment, patches having the same density are arranged in a plurality of positions on a sheet for each color of CMYK. The chart for density balance adjustment is used for suppressing density unevenness in the sheet surface.

The control unit 11 causes the display 12 to display a colorimetry screen.

The user uses the colorimeter 60 to perform the colorimetry on each patch of the chart for density balance adjustment.

The control unit 11 is connected to the colorimeter 60 via the colorimetric data receiver 16, receives the colorimetry result from the colorimeter 60, and displays the colorimetry result.

Furthermore, the control unit 11 may transmit the colorimetry result to the printer 20 (engine 30) via the communicator 14.

Next, the control unit 11 calculates, on the basis of the colorimetry result, an adjustment value for adjusting the density balance (unevenness in the sheet surface). Factors of the unevenness in the sheet surface include a screen, a sheet type, a basis weight, and the like.

The control unit 11 causes the display 12 to display a screen for registering the adjusted density balance as a “profile”.

In response to a registration instruction from the user, the control unit 11 causes the engine 30 to register the adjustment value (profile) of the density balance together with setting values of the screen, the sheet type, the basis weight, or the like. This profile is automatically selected according to the sheet type at the time of normal printing, or is manually specified at the time of print setting.

So far, the adjustment has been performed on the engine 30, and therefore, the adjustment has been performed on the basis of the sheet supported by the engine 30 side. The next calibration and profile creation (profiling) are adjustments in the controller 40. The controller 40 adjusts and manages colors for a wide variety of sheets on the basis of the color management target setting created in accordance with the final printed product.

### (Calibration)

Next, calibration (a density adjustment function for each sheet type) will be described.

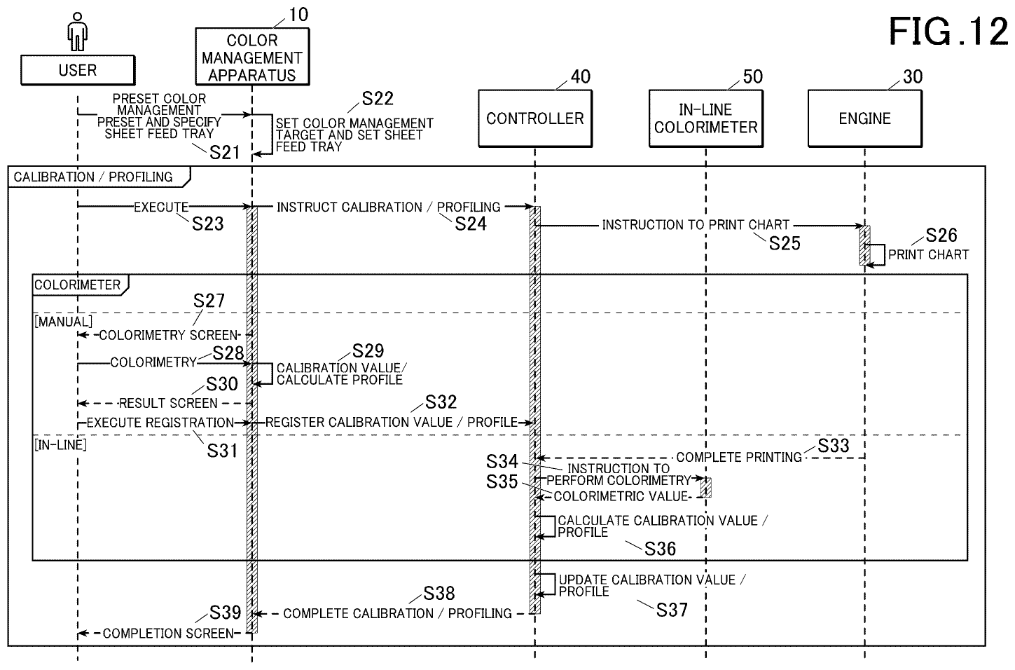

FIG. 12 is a sequence diagram at the time of executing calibration or profile creation.

When the user presses the “calibration” icon 153 on the menu screen 150 (see FIG. 9) on the color management application, the control unit 11 causes the display 12 to display a color management preset list screen.

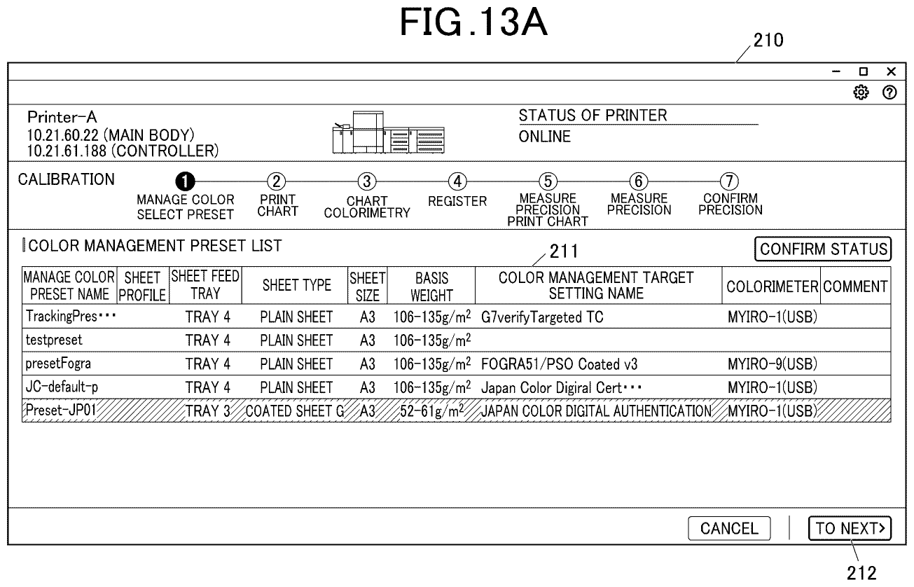

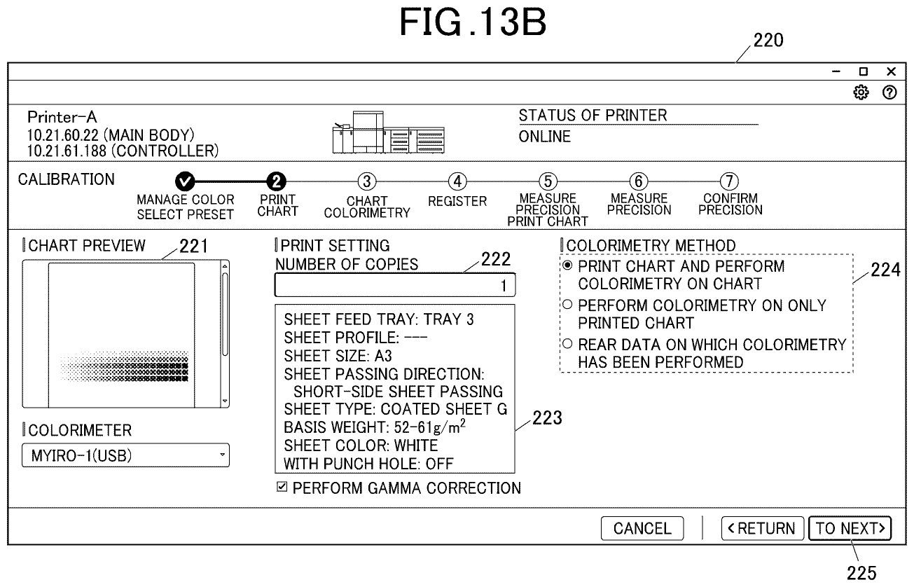

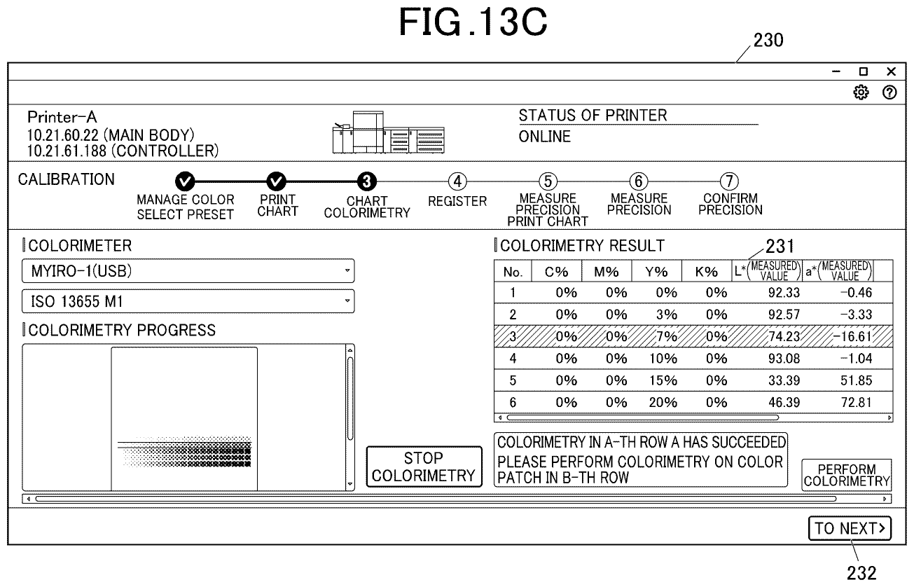

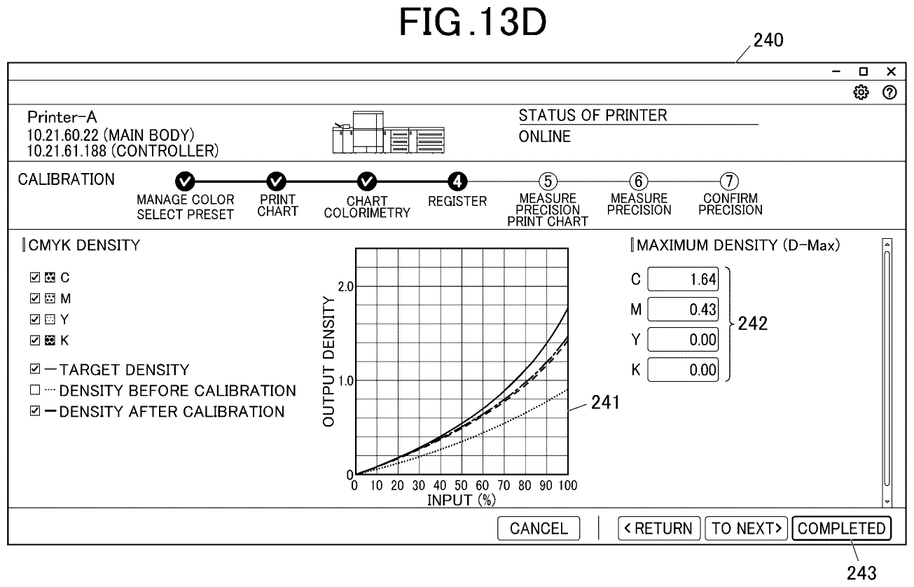

FIG. 13A illustrates an example of a color management preset list screen 210. The color management preset list screen 210 includes a color management preset list field 211, a next button 212, and the like. The control unit 11 refers to the color management preset table T3 in the storage 15 and causes the color management preset list field 211 to display a list of color management presets including the printer 20 to be subjected to the color management.

The user specifies any one of the color management presets from the color management preset list field 211 through an operation on the operation part 13 (Step S21). Thus, the user has specified the “sheet feed tray” and the “color management target setting” to be used.

The control unit 11 sets the “color management target setting” and the “sheet feed tray” included in the specified color management preset (Step S22). That is, the control unit 11 controls the color management and adjustment function of the controller 40 on the basis of the color management target setting associated with the color management preset (sheet print setting information) specified by the user.

When the user presses the next button 212 on the color management preset list screen 210 through an operation on the operation part 13, the control unit 11 causes the display 12 to display the chart print screen.

FIG. 13B illustrates an example of a chart print screen 220. The chart print screen 220 includes a chart preview field 221, a number-of-copies input field 222, a chart sheet information display field 223, a colorimetry method selection field 224, a next button 225, and the like.

A preview of a chart for calibration is displayed in the chart preview field 221.

In the number-of-copies input field 222, the number of copies of the chart to be printed in the calibration is input.

The sheet information of the sheet on which the chart is printed is displayed in the chart sheet information display field 223.

In the colorimetry method selection field 224, it is selected whether to print a chart and perform colorimetry, to perform colorimetry on the printed chart, or to read the data on which colorimetry has been performed.

The user performs various settings on the chart printing screen 220 through an operation on the operation part 13.

The user presses the next button 225 to issue an instruction to execute the calibration (Step S23).

The control unit 11 transmits an instruction to execute the calibration to the controller 40 via the communicator 14 (Step S24). The instruction to execute the calibration includes an instruction to print a chart.

The controller control unit 41 of the controller 40 transmits an instruction to print a calibration chart to the engine 30 (Step S25).

The engine control unit 31 of the engine 30 controls each component of the engine 30 to print a calibration chart (Step S26). The calibration chart includes, for each color of the CMYK, a patch group indicating a plurality of densities (gradations). In the colorimetry method selection field 224, when colorimetry of the printed chart is selected, or when reading of data subjected to colorimetry is selected, the chart is not printed.

Next, the control unit 11 causes the display 12 to display a colorimetry screen (Step S27).

FIG. 13C illustrates an example of the colorimetry screen 230. The colorimetry screen 230 includes a colorimetry result field 231, a next button 232, and the like.

The user performs the colorimetry on each patch of the calibration chart with the colorimeter 60 (Step S28).

The control unit 11 is connected to the colorimeter 60 via the colorimetric data receiver 16, and receives a colorimetry result (a colorimetric value and a density value) from the colorimeter 60. The control unit 11 causes the colorimetry result field 231 on the colorimetry screen 230 to display the colorimetry result of each patch.

Furthermore, the control unit 11 may transmit the colorimetry result to the printer 20 (controller 40) via the communicator 14.

When the user presses the next button 232 on the colorimetry screen 230, the control unit 11 calculates a calibration value for adjusting the density on the basis of the colorimetry result (Step S29).

The control unit 11 causes the display 12 to display a result screen (Step S30).

FIG. 13D illustrates an example of a result screen 240. The result screen 240 includes an output density graph display field 241, a maximum density display field 242, a completion button 243, and the like. The control unit 11 causes the output density graph display field 241 to display a graph of the output density with respect to the input. To be specific, the control unit 11 causes a density graph to be displayed for each color of CMYK. Whether to display the graphs of the density before calibration, the density after calibration, and the target density may be switchable.

For the first time, a density curve for which calibration has not been performed is displayed in the output density graph display field 241. When the density curve is along the target curve, there is no particular additional work. On the other hand, in a case where the density curve is shifted from the target curve, the printing of the chart, the colorimetry, and the display of the density graph are repeated again.

In the maximum density display column 242, the maximum density is displayed for each color of CMYK.

Before the chart is printed again, the controller 40 may calculate and adjust the difference between the target curve and the density curve on the basis of the colorimetric value. In this case, the control unit 11 of the color management apparatus 10 may only request the controller 40 to reprint the chart and re-execute the calibration.

The user presses the completion button 243 on the result screen 240 to issue an instruction to execute registration of the calibration value (Step S31).

The control unit 11 transmits an instruction to register the calibration value to the controller 40 via the communicator 14 (Step S32).

The controller control unit 41 of the controller 40 causes the storage 42 to store the calibration value transmitted from the color management apparatus 10, and updates the calibration value (Step S37).

On the other hand, when the printer 20 includes the in-line colorimeter 50, the following processes are performed instead of the processes of Steps S27 to S32.

After the chart is printed by the engine 30 (Step S26), the engine control unit 31 of the engine 30 issues a notification indicating the completion of printing to the controller 40 (Step S33).

The controller control unit 41 of the controller 40 issues an instruction to perform colorimetry to the in-line colorimeter 50 (Step S34).

The in-line colorimeter 50 performs colorimetry on each patch of the calibration chart. The controller control unit 41 of the controller 40 acquires a colorimetry result (a colorimetric value and a density value) from the in-line colorimeter 50 (Step S35).

The controller control unit 41 of the controller 40 calculates a calibration value for adjusting the density on the basis of the colorimetry result (Step S36).

The controller control unit 41 causes the storage 42 to store the calculated calibration value and updates the calibration value (Step S37).

After Step S37, the controller control unit 41 of the controller 40 transmits information indicating that the calibration has been completed to the color management apparatus 10 (Step S38).

The control unit 11 of the color management apparatus 10 causes the display 12 to display a calibration completion screen (Step S39).

### (Profile Creation)

Next, creation of a profile for each sheet type will be described.

Also in the profile creation, the flow of adjustment is roughly similar to that of the calibration (see FIG. 12).

Here, the case of manual colorimetry will be described.

When the user presses the “profile creation” icon 154 on the menu screen 150 (see FIG. 9) on the color management application, the control unit 11 causes the display 12 to display a color management preset list screen.

The user specifies any one of the color management presets from the list screen through an operation on the operation part 13.

The control unit 11 sets the “color management target setting” and the “sheet feed tray” included in the specified color management preset.

The control unit 11 causes a preview of a chart for profile creation to be displayed. The control unit 11 causes the display 12 to display a setting screen related to printing or colorimetry.

The user performs various settings related to printing or colorimetry.

The user issues an instruction to execute profile creation (profiling).

The control unit 11 transmits an instruction to execute profile creation to the controller 40 via the communicator 14. The instruction to execute profile creation includes an instruction to print a chart.

The controller control unit 41 of the controller 40 transmits, to the engine 30, an instruction to print a profile creation chart. At this time, the controller control unit 41 issues a print instruction without applying the existing profile on the controller 40 side as print setting.

The engine control unit 31 of the engine 30 controls each component of the engine 30 to print the profile creation chart. The profile creation chart includes a patch group of a plurality of colors. Target chromaticities (L*a*b* values, etc) are predetermined for each patch.

Next, the control unit 11 causes the display 12 to display a colorimetry screen.

The user uses the colorimeter 60 to perform the colorimetry on each patch of the profile creation chart.

The control unit 11 is connected to the colorimeter 60 via the colorimetric data receiver 16, receives a colorimetry result from the colorimeter 60, and causes the display 12 to display the colorimetry result.

Furthermore, the control unit 11 may transmit the colorimetry result to the printer 20 (controller 40) via the communicator 14.

The control unit 11 calculates a profile on the basis of the colorimetry result.

The control unit 11 causes the display 12 to display a result screen of profile creation.

The user issues an instruction to execute registration of a profile.

The control unit 11 transmits the instruction to register a profile to the controller 40 via the communicator 14.

The controller control unit 41 of the controller 40 causes the storage 42 to store the profile transmitted from the color management apparatus 10, and updates the profile.

Thereafter, when the printed product is printed, the user specifies the registered profile, thereby enabling printing to which the profile is applied.

### (Common to Color Management and Adjustment Function)

The control unit 11 communicates with the engine 30 or the controller 40 immediately after any one of the color management and adjustment functions is selected from the menu screen. Then, the control unit 11 acquires the latest sheet information from the engine 30 or the controller 40 and updates the printer information on the corresponding printer 20. At this time, the control unit 11 checks the color management preset associated with the printer 20 and determines whether the sheet specified in the color management target setting of each color management preset is set in a sheet feed tray of the printer 20. When the sheet specified in the color management target setting is not set in the sheet feed tray, the control unit 11 stops the color management and adjustment work and causes the display 12 to display a warning screen. The control unit 11 prompts the user to confirm and set the sheet by the display of the warning screen.

In addition, in a case where the sheet information related to each printer 20 is managed by an external apparatus (dedicated sheet management device), the control unit 11 acquires the sheet information from the external apparatus.

### (Color Verification Function)

Next, the color verification function will be described.

When the user presses the “color verification” icon 155 on the menu screen 150 (see FIG. 9) on the color management application, the control unit 11 executes the color verification function for the printer 20 to be subjected to the color management.

Since the “color management preset” has already been selected at the time of color management and adjustment, the control unit 11 starts executing the color verification function with the “color management preset” being selected.

The control unit 11 reads the setting value of the “color verification setting” from the “color management target setting” included in the “color management preset”. In addition, the control unit 11 reads the setting values of the “sheet information” and the “print setting” from the “sheet print setting information” included in the “color management preset”.

The control unit 11 causes the printer 20 that applies the “color management target setting” to print a color verification chart (patch group) corresponding to the “color management target setting”. The control unit 11 specifies a color verification chart and transmits an instruction to print a chart including setting information such as a sheet feed tray, a screen, the number of copies, and an application profile at the time of color verification to the controller 40 including the printer 20 to be subjected to the color management.

Before transmitting the instruction to print the chart, the control unit 11 may cause the display 12 to display a preview of the chart or display a setting screen including a number-of-copies input field and the like.

The controller control unit 41 of the controller 40 transmits an instruction to print the color verification chart to the engine 30.

The engine control unit 31 of the engine 30 controls each components of the engine 30 to print the color verification chart. The color verification chart includes a patch group of a plurality of colors.

Since the colorimetry operation of the color verification chart is the same as the colorimetry of the color management and adjustment chart described above, the description thereof will be omitted.

The control unit 11 compares the colorimetry result with the color verification standard and/or each allowable value, and determines whether the color printed by the printer 20 satisfies the color management target setting. The control unit 11 causes the display 12 to display the determination result. The determination result screen for color verification includes, for each determination item, an allowable value, a value calculated from a colorimetric value, a determination result (Fail/Pass), and the like.

As described above, according to the present embodiment, the control unit 11 of the color management apparatus 10 controls the color management and adjustment function of the engine 30 and the color management and adjustment function of the controller 40 from the outside of the printer 20. In the conventional color management and adjustment function of the engine 30, a user has to perform the operation from a main body panel of the printer 20. On the other hand, the control unit 11 can control the color management and adjustment functions of the engine 30 and the controller 40 from the outside of the printer 20. Thus, the control unit 11 can make the color adjustment of the printer 20 more efficiently.

The control unit 11 controls the color management and adjustment function of the engine 30 and the color management and adjustment function of the controller 40 on the basis of the color management preset (color management setting information). The control unit 11 can control the color management and adjustment function of the engine 30 and the color management and adjustment function of the controller 40 on the basis of the color management target setting associated with the printer information or the sheet printing setting information.

On the basis of the color management target setting associated with the specified sheet print setting information, the control unit 11 controls the color management and adjustment function of the engine 30 and the color management and adjustment function of the controller 40. The control unit 11 can improve the efficiency of the color adjustment of the printer 20 by executing the color adjustment while automatically selecting the sheet according to the color management target setting. The user can operate the color adjustment work of the printer 20 from the color management application.

The control unit 11 can update the sheet information acquired from the controller 40 as a part of the printer information including the controller information indicating the controller 40 stored in the storage 15.

The control unit 11 can update the sheet information acquired from the engine 30 as a part of the printer information including the engine information indicating the engine 30 stored in the storage 15.

The control unit 11 can update the sheet information acquired from the dedicated sheet management apparatus as part of the printer information including the engine information indicating the engine 30 or the controller information indicating the controller 40 stored in the storage 15.

The control unit 11 acquires the latest sheet information from the engine 30 or the controller 40 immediately before the color management and adjustment of the engine 30 or the color management and adjustment of the controller 40. When the sheet to be subjected to the color management and adjustment is not set in any sheet feed tray of the printer 20, the control unit 11 stops the execution of the color management and adjustment, and issues an error notification indicating that the sheet to be subjected to the color management and adjustment is not set. By acquiring the latest sheet information from the printer 20 immediately before the color management and adjustment, the control unit 11 can notify the user that no target sheet is set. Therefore, the control unit 11 can efficiently perform color adjustment of the printer 20.

The control unit 11 can control an adjustment function related to the maximum density of an image printed by the engine 30 or an adjustment function related to density balance. Furthermore, when the engine 30 has an adjustment function (calibration function) related to the density, the control unit 11 may be able to control the adjustment function related to the density of the engine 30.

In addition, the control unit 11 can control an adjustment function (calibration function) related to the density of an image printed by the engine 30 corresponding to the controller 40 for each sheet type or a profile creation function.

Note that the description in the above embodiment is an example of an external control apparatus and a recording medium storing a program according to the present invention, and the present invention is not limited to this. The detailed configuration and detailed operation of each apparatus constituting the system can also be appropriately changed without departing from the spirit of the present invention.

For example, the control unit 11 of the color management apparatus 10 may automatically execute the color verification function after the color management and adjustment of the engine 30 or the color management and adjustment of the controller 40 is completed. Since the “color management preset” has already been selected at the time of the color management and adjustment, the control unit 11 starts execution of the color verification function with the “color management preset” being selected. To be specific, the control unit 11 causes the display 12 to automatically display an operation screen for accepting an instruction to execute color verification at the timing when the color management and adjustment of the engine 30 or the controller 40 is completed. Alternatively, the control unit 11 may automatically start the execution of the color verification function for the printer 20 at the timing when the color management and adjustment of the engine 30 or the controller 40 is completed. In addition, the control unit 11 may automatically execute the color verification function after a series of color management and adjustment (maximum density adjustment, density balance adjustment, calibration, and profile creation) in the printer 20 is completed. Specific processing of the color verification function is similar to the content described above, and therefore, description thereof is omitted.

Accordingly, after the color management and adjustment of the printer 20 is completed, the control unit 11 can smoothly execute the color verification of the printer 20.

Furthermore, the control unit 11 may divert the “color management target setting” included in the registered “color management preset” and associate it with another printer 20, thereby registering it as “another color management preset”. To be specific, in response to a user operation, the control unit 11 causes the storage 15 (the color management preset table T3) to store a first color management preset (first color management setting information). After the first color management preset is stored in the storage 15, the control unit 11 determines whether a printer 20 of the same model as the engine information and the controller information included in the first color management preset exists in the network. For example, when the “model name” of the printers 20 is the same, the control unit 11 determines that the printers 20 are of the same model. When the printers 20 of the same model exist in the network, the control unit 11 diverts the first color management preset to create a second color management preset (second color management setting information) including engine information and controller information related to the printer 20 of the same model. The control unit 11 causes the color management preset table T3 in the storage 15 to store the created second color management preset.

Thus, the control unit 11 can divert the registered “color management preset” to create a “color management preset” corresponding to the printer 20 of the same model.

In addition, calculation of adjustment values and the like in each color management and adjustment function may be performed by any of the control unit 11 of the color management apparatus 10, the engine control unit 31 of the engine 30, and the controller control unit 41 of the controller 40.

Furthermore, the program for executing each process in each apparatus may be stored in a portable recording medium. Furthermore, a carrier wave may be applied as a medium for providing data of the program via a communication line.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-188760 filed on Nov. 2, 2024 is incorporated herein by reference in its entirety.

What is claimed is:

1. An external control apparatus of a printer, wherein:
the printer includes an engine that performs printing on a sheet and a controller that generates raster data to be provided to the engine, and
the external control apparatus comprises:
a hardware processor that controls, from an outside of the printer, a color management and adjustment function of the engine and a color management and adjustment function of the controller.

2. The external control apparatus according to claim 1, further comprising:
a storage that stores color management setting information in which color management target setting, sheet print setting information, and printer information including engine information indicating the engine and controller information indicating the controller are associated with each other,
wherein the hardware processor controls a color management and adjustment function of the engine and a color management and adjustment function of the controller on a basis of the color management setting information.

3. The external control apparatus according to claim 2, further comprising:
an acceptor that accepts specification of sheet print setting information included in the color management setting information stored in the storage,
wherein the hardware processor controls the color management and adjustment function of the engine and the color management and adjustment function of the controller on the basis of the color management target setting associated with the specified sheet print setting information.

4. The external control apparatus according to claim 2, wherein
the hardware processor acquires, from the controller, sheet information managed by the controller, and updates the acquired sheet information as a part of printer information including controller information indicating the controller stored in the storage.

5. The external control apparatus according to claim 4, wherein
when the hardware processor fails to acquire sheet information managed by the controller from the controller, the hardware processor acquires sheet information managed by the engine from the engine, and updates the acquired sheet information as a part of printer information including engine information indicating the engine stored in the storage.

6. The external control apparatus according to claim 2, wherein
the hardware processor acquires sheet information related to the printer from an external apparatus other than the engine and the controller, and updates the acquired sheet information as a part of printer information including engine information indicating the engine or controller information indicating the controller that is stored in the storage.

7. The external control apparatus according to claim 2, wherein
the hardware processor acquires latest sheet information from the engine or the controller immediately before the color management and adjustment of the engine or the color management and adjustment of the controller, and in a case where a sheet to be subjected to the color management and adjustment is not set in any sheet feed tray of the printer, the hardware processor stops execution of the color management and adjustment and issues an error notification indicating that the sheet to be subjected to the color management and adjustment is not set.

8. The external control apparatus according to claim 4, wherein
the sheet information includes a list of sheet feed trays, and information indicating a sheet type and a sheet passing direction for each of the sheet feed trays.

9. The external control apparatus according to claim 1, wherein
the color management and adjustment function of the engine includes an adjustment function related to a maximum density of an image printed by the engine, an adjustment function related to density balance, or an adjustment function related to a density, and
the color management and adjustment function of the controller includes an adjustment function related to a density of an image to be printed by the engine corresponding to the controller for each sheet type, or a profile creation function.

10. The external control apparatus according to claim 1, wherein
the hardware processor automatically executes a color verification function after the color management and adjustment of the engine or the color management and adjustment of the controller is completed.

11. The external control apparatus according to claim 2, wherein
the hardware processor has a function of searching for a printer in a network and acquiring printer information of the printer, and
when a printer of the same model as the engine information and the controller information included in first color management setting information exists in the network after the first color management setting information is stored in the storage, the hardware processor creates second color management setting information including engine information and controller information related to the printer of the same model by diverting the first color management setting information.

12. A non-transitory computer readable medium storing a program causing
a computer connected to a printer including an engine that performs printing on a sheet and a controller that generates raster data to be provided to the engine through a network, to perform:
functioning as a control unit that controls a color management and adjustment function of the engine and a color management and adjustment function of the controller from an outside of the printer.
